(19) United States
(12) Patent Application Publication
(10) Pub. No.: US 2022/0198379 A1
(43) Pub. Date: Jun. 23, 2022

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Satoshi KOMAMINE, Nagoya-shi (JP)

(73) Assignee: TOYOTA JIDOSHA KABUSHIKI KAISHA, Toyota-shi (JP)

(21) Appl. No.: 17/548,950

(22) Filed: Dec. 13, 2021

(30) Foreign Application Priority Data
Dec. 18, 2020 (JP) 2020-210638

(51) Int. Cl. G06Q 10/08; G01G 21/22; G01G 21/28; G01G 23/37

(52) U.S. Cl. CPC G06Q 10/087; G01G 23/37; G01G 21/283; G01G 21/22

(57) ABSTRACT

An information processing apparatus including a processor, the processor being configured to execute acquiring a quantity of stock of a first product stored at a storage place based on a measured value indicating a weight of a load at the storage place by a weight sensor installed at the storage place. The processor executes: acquiring a weight per one article of the first product; and determining, when there is an increase or decrease from a last measured value to the current measured value of the weight sensor, whether or not the increase or decrease in the measurement value is due to addition or reduction of the first product, based on the weight per one article. The processor executes updating the quantity of stock of the first product when it is determined that the increase or decrease in the measured value is due to addition or reduction of the first product.

### CROSS REFERENCE TO THE RELATED APPLICATION

This application claims the benefit of Japanese Patent Application No. 2020-210638, filed on Dec. 18, 2020, which is hereby incorporated by reference herein in its entirety.

### BACKGROUND

### Technical Field

The present disclosure relates to an information processing apparatus and an information processing method.

### Description of the Related Art

A stock management system is disclosed in which stock management is performed by measurement data of a weight sensor that measures a weight of a product placed on a top board of a case, and the product is ordered when a remaining quantity is smaller than a proper quantity of stock (for example, Japanese Patent Laid-Open No. 2020-008331).

However, the product placed on the top board of the case is a single product, and it is not possible to accurately grasp a quantity of stock if other products are mixed to the product.

A subject of one of disclosed aspects is to provide an information processing apparatus capable of, even when unassumed products are mixed into a storage place where products to be stored are assumed, performing stock management more accurately, and an information processing method.

### SUMMARY

One aspect of the present disclosure is an information processing apparatus comprising a processor, the processor being configured to execute acquiring a quantity of stock of a first product stored at a storage place based on a measured value indicating a weight of a load at the storage place by a weight sensor installed at the storage place, wherein

the processor executes:

acquiring a weight per one article of the first product;

determining, when there is an increase or decrease from a last measured value to the current measured value of the weight sensor, whether or not the increase or decrease in the measurement value is due to addition or reduction of the first product, based on the weight per one article; and

updating the quantity of stock when it is determined that the increase or decrease in the measured value is due to addition or reduction of the first product, and not updating the quantity of stock when it is determined that the increase or decrease in the measured value is not due to addition or reduction of the first product.

Another aspect of the present disclosure is an information processing method executed by a computer configured to execute acquiring a quantity of stock of a first product stored at a storage place based on a measured value indicating a weight of a load at the storage place by a weight sensor installed at the storage place, the method comprising:

acquiring a weight per one article of the first product;

determining, when there is an increase or decrease from a last measured value to the current measured value of the weight sensor, whether or not the increase or decrease in the measurement value is due to addition or reduction of the first product, based on the weight per one article; and

updating the quantity of stock when it is determined that the increase or decrease in the measured value is due to addition or reduction of the first product, and not updating the quantity of stock when it is determined that the increase or decrease in the measured value is not due to addition or reduction of the first product.

According to one of aspects of the present disclosure, it is possible to, even when unassumed products are mixed into a storage place where products to be stored are assumed, perform stock management more accurately.

### BRIEF DESCRIPTION OF THE DRAWINGS

FIG. 1 is a diagram illustrating an example of a configuration of a stock management system according to a first embodiment;

FIG. 2 is a diagram illustrating examples of hardware components of the management server, the sensor apparatus and the user terminal according to the first embodiment;

FIG. 3 is a diagram illustrating examples of functional components of the management server, the sensor apparatus and the user terminal according to the first embodiment;

FIG. 4 illustrates an example of information held in the stock information database;

FIG. 5 illustrates an example of a flowchart of a process for managing the estimated quantity of stock of the products by the management server;

FIG. 6 illustrates an example of a time chart of transition of the estimated quantity of stock of the product in stock management by the stock management system in a case where products other than the product are not mixed on the storage place;

FIG. 7 illustrates an example of a time chart of transition of the estimated quantity of stock of the product by stock management according to the measured value of the weight sensor in a case where products other than the product are mixed;

FIG. 8 illustrates an example of a time chart of transition of the estimated quantity of stock of the product in stock management by the stock management system in the case where products other than product are mixed to the storage place;

FIG. 9 illustrates an example of a flowchart of a process for managing the estimated quantity of stock of the product by the management server according to the modification; and

FIG. 10 illustrates an example of a flowchart of a process for managing the estimated quantity of stock of the product by the management server according to the modification.

### DESCRIPTION OF THE EMBODIMENTS

One of aspects of the present disclosure is an information processing apparatus including a processor, the processor being configured to execute acquiring a quantity of stock of a first product stored at a storage place based on a measured value indicating a weight of a load at the storage place by a weight sensor installed at the storage place. The processor may execute: acquiring a weight per one article of the first product; and determining, when there is an increase or decrease from a last measured value to the current measured value of the weight sensor, whether or not the increase or decrease in the measurement value is due to addition or reduction of the first product, based on the weight per one article. The processor may execute updating the quantity of stock of the first product when it is determined that the increase or decrease in the measured value is due to addition or reduction of the first product, and not updating the quantity of stock of the first product when it is determined that the increase or decrease in the measured value is not due to addition or reduction of the first product.

The information processing apparatus is, for example, a server. Further, the information processing apparatus may be a computer or the like that is connected to a personal computer (PC) existing near the storage place and the weight sensor. The storage place may be a storage shelf, a storage box, a box or the like in a user's home, an office or a factory.

According to the one of the aspects of the present disclosure, if another product different from the first product have been added to the storage place where the first product is stored, the quantity of stock of the first product is not updated. Therefore, it is possible to manage the quantity of stock of the first product more accurately.

In one of the aspects of the present disclosure, the processor may determine whether or not the increase or decrease in the measured value is due to addition or reduction of the first product by whether or not a quantity of the increase or decrease in the measured value is a multiple of the weight per one article. Thereby, it is possible to detect addition or reduction of the first product to or from the storage place more accurately even without using sensors other than the weight sensor. Further, it is possible to detect that a product other than the first product have been added to or reduced from the storage place.

In one of the aspects of the present disclosure, the processor may be adapted to, when determining that the increase or decrease in the measured value is not due to addition or reduction of the first product, confirm whether or not to reflect a quantity of the increase or decrease in the measured value on the quantity of stock, to a user associated with the storage place. In response to a request to store product that is different from the first product but is of the same kind, at the same storage place as the first product, it is possible to cause such a product that is different from the first product but are of the same kind to be stock management target. The product of the same kind is product the brand of which is different from that of the first product but is the same in item category. Specifically, if the first product is soy sauce with a brand name of A, the product that is different from the first product but is of the same kind is soy sauce with a brand name of B.

In one of the aspects of the present disclosure, the processor may determine whether or not the quantity of the increase or decrease in the measured value is a multiple of a weight per one article of another product when determining that the increase or decrease in the measured value is not due to addition or reduction of the first product. The processor may be adapted to notify a user associated with the storage place of mixture of the other product to the storage place when the quantity of the increase or decrease in the measured value is a multiple of the weight per one article of the other product. Thereby, it is possible to remind the user of the mixture of the other product to the storage place. For example, when the other product is a product stored at another storage place associated with the user and provided with another weight sensor, it is possible to cause the user to notice that the storage place is wrong.

In one of the aspects of the present disclosure, the processor may be adapted to, when the quantity of stock is below a predetermined value, further execute transmitting a signal about replenishment of the first product. The signal about replenishment of the first product may be, for example, a signal to order the first product. Or alternatively, the signal about replenishment of the first product may be a signal notifying a user associated with the storage place that the quantity of stock is below the predetermined value. Thereby, it is possible to provide support for keeping the quantity of stock of the first product constant.

In one of the aspects of the present disclosure, the first product and a second product may be mixed and stored at the storage place. In this case, the processor may further acquire a weight per one article of the second product. The processor may determine, when there is the increase or decrease from the last measured value to the current measured value of the weight sensor, whether or not the increase or decrease in the measurement value is due to addition or reduction of at least one of the first product and the second product, based on the weight per one article of the first product and the weight per one article of the second product. Further, the processor may be adapted to update at least one of the quantity of stock of the first product and a quantity of stock of the second product when determining that the increase or decrease in the measured value is due to addition or reduction of at least one of the first product and the second product, and updating neither the quantity of stock of the first product nor the quantity of stock of the second product when determining that the increase or decrease in the measured value is not due to addition or reduction of the first product or the second product. The processor may be adapted to, when a quantity of the increase or decrease in the measured value does not correspond to any of weights of combinations of the numbers of articles of the first product and the numbers of articles of the second product, determine that the increase or decrease in the measured value is not due to addition or reduction of the first product or the second product. Thereby, even when the first product and the second product are mixed at the storage place, it is possible to manage the quantity of stock of the first product and the quantity of stock of the second product without using sensors other than the weight sensor.

In the following, an embodiment of the present disclosure will be described with reference to the drawings. The configuration of the embodiment described below is an example, and the present disclosure is not limited to the configuration of the embodiment.

### First Embodiment

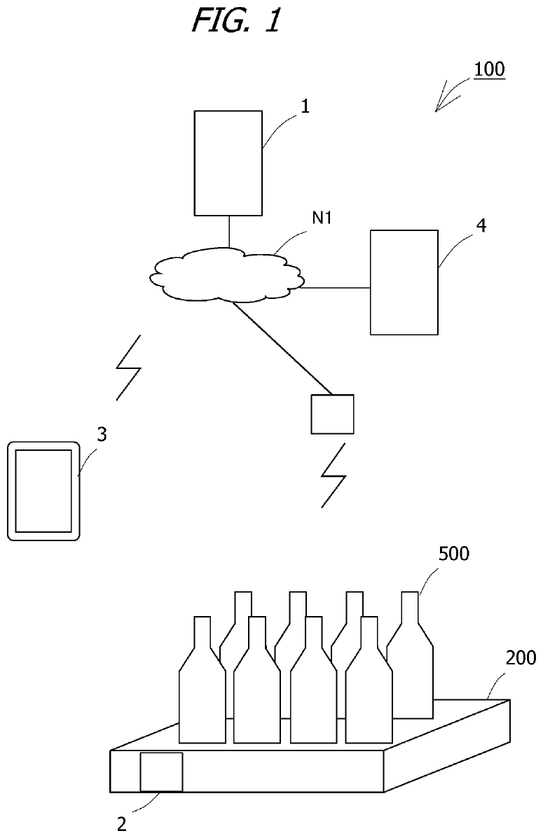

FIG. 1 is a diagram illustrating an example of a configuration of a stock management system 100 according to a first embodiment. The stock management system 100 is a system for managing stock of purchased products stored at a predetermined storage place, for example, in a user's home or the like. The stock management system 100 includes a management server 1, a sensor apparatus 2 provided for a storage place 200 and a user terminal 3 of a user associated with the sensor apparatus 2. In the example illustrated in FIG. 1, the storage place 200 indicates a storage box or a tier of storage shelves set in the user's home. However, the storage place 200 is not limited thereto and may be a box, a mat or the like on which the sensor apparatus 2 is installed. Further, the storage place 200 may be installed in an office, a factory and the like.

In the first embodiment, it is assumed that products 500 stored in the storage place 200 are limited to a single product registered in advance. Further, in the first embodiment, it is assumed that the product 500 is loaded not on a plurality of tiers but on one plate on which a weight of a load can be detected by one weight sensor.

A network N1 is, for example, a public network such as the Internet. The management server 1, the sensor apparatus 2 and the user terminal 3 are connected to the network N1. The sensor apparatus 2 and the user terminal 3 can communicate with the management server 1 via the network N1.

The sensor apparatus 2 is, for example, a control apparatus provided with a weight sensor that measures a weight of a load on the storage place 200. The sensor apparatus 2 may be such that is sold, being integrated with the storage place 200 or may be such that is separately sold and can be retrofitted to the storage place 200. The sensor apparatus 2 wirelessly connects, for example, to a relay apparatus installed in the home to connect to the network N1.

The products 500 stored at the storage place 200 are, for example, food products such as beverages, food and seasoning, daily necessity, cleansing agent or the like. However, articles stored at the storage place 200 are not limited thereto. When having measured the weight of the load on the storage place 200 in a predetermined period, for example, the sensor apparatus 2 transmits a measured value to the management server 1. However, without being limited thereto, the sensor apparatus 2 may transmit a measured value to the management server 1 when there is a change in the weight of the load on the storage place 200.

When receiving the measured value of the weight from the sensor apparatus 2, the management server 1 updates a quantity of stock of the product 500 stored at the storage place 200 if a quantity of an increase or decrease from the last measured value is a multiple of a weight per one article of the product 500. On the other hand, if the quantity of the increase or decrease from the last measured value is not a multiple of the weight per one article of the product 500, the management server 1 determines that a product other than the product 500 have been added or reduced and does not update the quantity of stock of the product 500 stored at the storage place 200. Since the quantity of stock of the product 500 stored at the storage place 200, which is grasped by the management server 1, is an estimated value, it will be hereinafter referred to simply as an estimated quantity of stock of the product 500.

When the estimated quantity of stock of the product 500 is below a predetermined value, the management server 1 transmits a signal about replenishment of the product 500. The signal about replenishment of the product 500 is, for example, a signal to order a predetermined quantity of product 500 from an external server 4 or a signal to notify the user that stock of the product 500 is small. The signal to order the product 500 from the external server 4 and the signal to notify the user that stock of the product 500 is small are examples of “a signal about replenishment of a first product”. The external server 4 is a server that manages actual stores or stores on the web.

According to the first embodiment, it is possible to accurately manage the estimated quantity of stock of the product 500 stored at the storage place 200 without using a sensor other than the weight sensor.

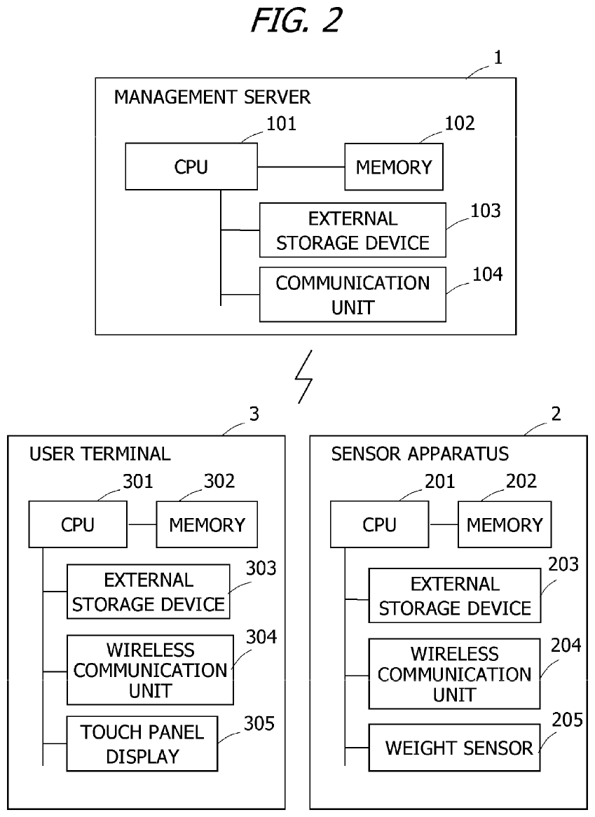

FIG. 2 is a diagram illustrating examples of hardware components of the management server 1, the sensor apparatus 2 and the user terminal 3 according to the first embodiment. As the hardware components, the management server 1 includes a central processing unit (CPU) 101, a memory 102, an external storage device 103 and a communication unit 104. The memory 102 and the external storage device 103 are computer-readable recording media. The management server 1 is an example of “an information processing apparatus”.

The external storage device 103 stores various programs and data used by the CPU 101 at the time of executing each program. The external storage device 103 is, for example, an erasable programmable ROM (EPROM) and/or a hard disk drive. The programs held in the external storage device 103 includes, for example, an operating system (OS), a control program of the stock management system 100 and other various application programs. The control program of the stock management system 100 is a program for performing stock management of the storage place 200.

The memory 102 is a main memory that provides a storage area to which a program stored in the external storage device 103 is loaded and a work area for the CPU 101 and is used as a buffer. The memory 102 includes, for example, a semiconductor memory like a read-only memory (ROM) and a random-access memory (RAM).

The CPU 101 executes various processes by loading the OS and various application programs held in the external storage device 103 to the memory 102 and executing them. The number of CPUs 101 is not limited to one, but a plurality of CPUs 101 may be provided. The CPU 101 is an example of “a processor”.

The communication unit 104 is an interface that performs input/output of information to/from a network. The communication unit 104 is, for example, a local area network (LAN) card or the like. However, the communication unit 104 is not limited thereto and may be an optical network unit (ONU) interface for optical line, for example. The hardware components of the management server 1 are not limited to those illustrated in FIG. 2.

As the hardware components, the sensor apparatus 2 includes a CPU 201, a memory 202, an external storage device 203, a wireless communication unit 204 and a weight sensor 205. The CPU 201, the memory 202 and the external storage device 203 are similar to the CPU 101, the memory 102 and the external storage device 103, respectively.

The wireless communication unit 204 is an interface that performs input/output of information to/from a network. The wireless communication unit 204 performs wireless communication, for example, WiFi, BLE (Bluetooth (registered trademark) Low Energy) or the like. For example, by connecting to the relay apparatus installed in the user's home, such as an access point, the wireless communication unit 204 accesses the network N1 and performs communication with the management server 1.

The weight sensor 205 measures the weight of the load on the storage place 200, for example, in a predetermined period. The measurement period of the weight sensor 205 is arbitrarily set, for example, within a range between 100 milliseconds to 1 minute. The weight sensor 205 outputs a measured value to the CPU 201. A plurality of weight sensors 205 may be connected to the sensor apparatus 2. For example, when the storage place 200 is storage shelves including a plurality of tiers, the weight sensor 205 is provided for each tier, and the estimated quantity of stock of the product 500 stored at the storage place 200 is managed by summing up estimated quantities of stock of the product 500 stored on the tiers.

The user terminal 3 is provided with a CPU 301, a memory 302, an external storage device 303, a wireless communication unit 304 and a touch panel display 305 as the hardware components. The CPU 301, the memory 302 and the external storage device 303 are similar to the CPU 101, the memory 102 and the external storage device 103, respectively. In the external storage device 303, a client application program of the stock management system 100 is stored.

The wireless communication unit 304 connects to the network N1 by a predetermined wireless communication method. The wireless communication unit 304 performs wireless communication, for example, by a mobile wireless communication method such as Long Term Evolution (LTE), LTE-Advanced and 5G, or WiFi.

The touch panel display 305 receives an operation input from the user and outputs the operation input to the CPU 301. Further, the touch panel display 305 displays an image inputted from the CPU 301. The hardware components of the management server 1, the sensor apparatus 2 and the user terminal 3 illustrated in FIG. 2 are mere examples, and hardware components are not limited thereto.

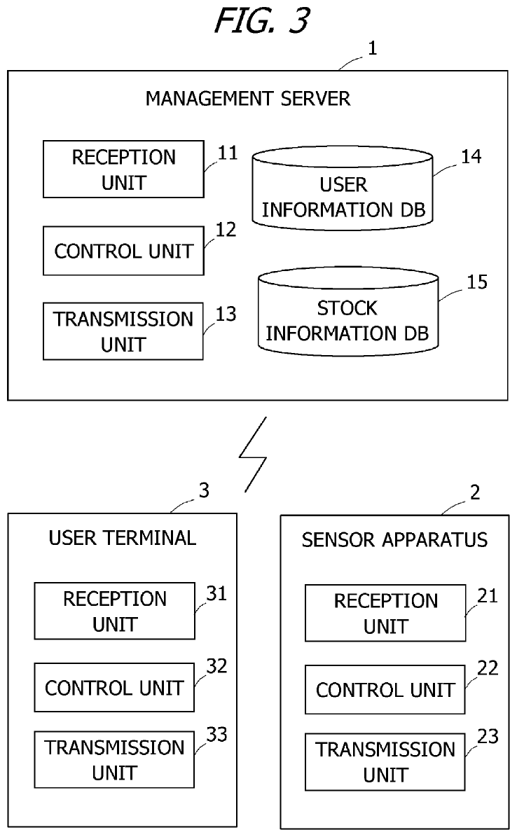

FIG. 3 is a diagram illustrating examples of functional components of the management server 1, the sensor apparatus 2 and the user terminal 3 according to the first embodiment. First, the sensor apparatus 2 includes a reception unit 21, a control unit 22 and a transmission unit 23 as the functional components. These functional components are achieved by the CPU 201 of the sensor apparatus 2 executing a predetermined program in the external storage device 203.

The reception unit 21 and the transmission unit 23 are interfaces with the management server 1. The transmission unit 23 transmits data inputted from the control unit 22 to the management server 1 through the wireless communication unit 204. The reception unit 21 receives data from the management server 1 through the wireless communication unit 204 and outputs the received data to the control unit 22.

The control unit 22 receives input of a measured value of the weight of the load on the storage place 200 from the weight sensor 205 in a predetermined period. When receiving the input of the measured value of the weight of the load on the storage place 200 from the weight sensor 205, the control unit 22 generates weight information and transmits the weight information to the management server 1 through the transmission unit 23. The weight information includes, for example, a time stamp, identification information about the weight sensor 205 and the measured value.

The management server 1 is provided with a reception unit 11, a control unit 12, a transmission unit 13, a user information DB 14 and a stock information DB 15 as the functional components. These functional components are achieved by the CPU 101 executing the control program of the stock management system 100.

The reception unit 11 and the transmission unit 13 are interfaces with the network N1. The reception unit 11 receives data, for example, from the sensor apparatus 2, the user terminal 3 and the external server 4 through the network N1 and outputs the data to the control unit 12. The transmission unit 13 transmits the data inputted from the control unit 12 to the user terminal 3 through the network N1.

The control unit 12 receives the weight information from the sensor apparatus 2 through the reception unit 11. The control unit 12 compares the last measured value and the current measured value and determines whether or not the current measured value has increased or decreased from the last measured value. If the current measured value has increased or decreased from the last measured value, the control unit 12 determines whether or not a weight of the increase or decrease from the last measured value is a multiple of the weight per one article of the product 500. If the weight of the increase or decrease from the last measured value is a multiple of the weight per one article of the product 500, the control unit 12 determines that the product 500 have been added to or reduced from the storage place 200 and updates the estimated quantity of stock of the product 500 in the stock information DB 15. If the current measured value has increased from the last measured value, the estimated quantity of stock is updated by adding a quantity corresponding to the increased weight. If the current measured value has decreased from the last measured value, the estimated quantity of stock is updated by subtracting a quantity corresponding to the decreased weight. The estimated quantity of stock may be indicated by a weight or by the number of articles of the product 500.

If the current measured value has not increased or decreased from the last measured value, and if the weight of the increase or decrease from the last measured value is not a multiple of the weight per one article of the product 500, the control unit 12 does not update the estimated quantity of stock of the product 500 in the first embodiment. This is because, if the weight of the increase or decrease from the last measured value is not a multiple of the weight per one article of the product 500, the control unit 12 determines that a product other than the product 500 have been added to or reduced from the storage place 200.

If the estimated quantity of stock of the product 500 is below the predetermined value, the control unit 12, for example, executes a process for ordering a predetermined quantity of product 500 from the external server 4 or notifies the user terminal 3 that the quantity of stock of product 500 is small. The threshold for the quantity of stock used in this process may differ depending on the products 500. Further, the threshold used in this process may be specified by the user.

The user information DB 14 and the stock information DB 15 are created in a storage area of the external storage device 103 of the management server 1. The user information DB 14 holds user information about the user. The user information includes, for example, identification information about the user, a name of the user, an address of the user and identification information about the weight sensor 205. The user information may include information about automatic order. The information about automatic order includes, for example, identification information about products targeted by automatic order, an order quantity per delivery and the like.

The stock information DB 15 holds information about the products 500 stored at the storage place 200 on which the sensor apparatus 2 is installed. Details of the information held in the stock information DB 15 will be described later.

The user terminal 3 is provided with a reception unit 31, a control unit 32 and a transmission unit 33 as the functional components. These functional components are achieved by the CPU 301 executing the client application program of the stock management system 100.

The reception unit 31 and the transmission unit 33 are interfaces with the management server 1. The transmission unit 33 transmits data inputted from the control unit 32 to the management server 1 through the wireless communication unit 304. The reception unit 31 receives data from the management server 1 through the wireless communication unit 304 and outputs the received data to the control unit 32.

The control unit 32 displays a notification received from the management server 1 through the reception unit 31 on the touch panel display 305, for example. Further, the control unit 32 transmits a response inputted from the user through the touch panel display 305 to the management server 1 through the transmission unit 33.

The functional components of the management server 1, the sensor apparatus 2 and the user terminal 3 are not limited to those illustrated in FIG. 3. For example, a part of the processes of the management server 1 may be performed by the sensor apparatus 2.

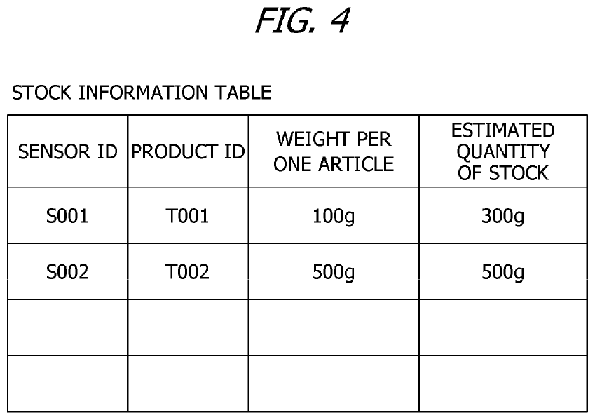

FIG. 4 illustrates an example of information held in the stock information DB 15. In the stock information DB 15, a stock information table is held for each user. The stock information table includes, fields of sensor ID, product ID, weight per one article, and estimated quantity of stock.

In the field of sensor ID, the identification information about the weight sensor 205 is stored. In the field of product ID, identification information about the product 500 stored at the storage place 200 corresponding to the weight sensor 205 is stored. In the field of weight per one article, the weight per one article of the product 500 is stored. In the field of estimated quantity of stock, the estimated quantity of stock of the product 500 stored at the storage place 200 corresponding to the weight sensor 205 is stored. In the field of estimated quantity of stock, either a weight or a number may be stored.

Values in the fields of sensor ID, product ID and weight per one article of the stock information table are registered by the user through the user terminal 3, for example. Or alternatively, the value in the field of weight per one article may be acquired from the web by the control unit 12 based on the value of the field of product ID.

The field of estimated quantity of stock is updated by the control unit 12 based on weight information from the sensor apparatus 2. For example, when the product 500 is stored on a plurality of tiers, and quantity of stock is managed by a plurality of weight sensors 205, the estimated quantity of stock of the product 500 is a total value of values of fields of estimated quantity of stock of entries in which the value of the field of product ID is identification information about the product 500.

The information held in the stock information table is not limited to that illustrated in FIG. 4. Further, methods of registering, updating and deleting an entry with, of and from the stock information table are not limited to the above methods. For example, the stock information table may be provided with a field for holding a threshold for the quantity of stock of the products 500. For example, the threshold for the quantity of stock of the products 500 may be specified by the user. Further, the stock information table may be provided with a field for specifying an action to be executed when the estimated quantity of stock of the products 500 is below the threshold. The action to be executed when the estimated quantity of stock of the products 500 is below the threshold is, for example, automatic order of the products 500, notification that the stock of the products 500 is small, and the like.

<Process Flow>

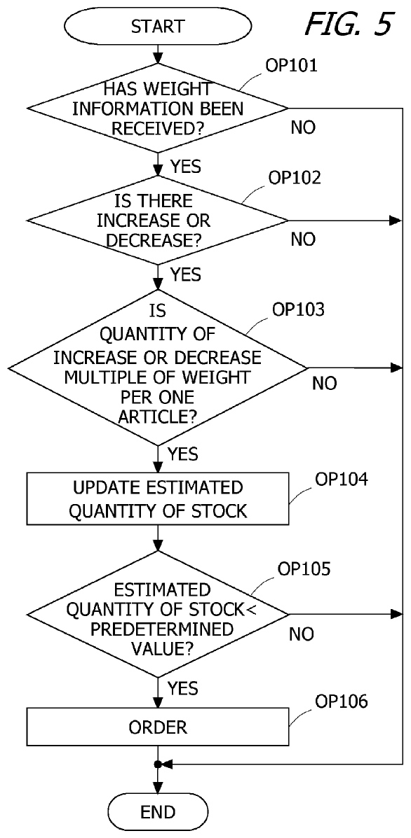

FIG. 5 illustrates an example of a flowchart of a process for managing the estimated quantity of stock of the products 500 by the management server 1. The process illustrated in FIG. 5 is repeatedly executed in a predetermined period. Though an executor of the process illustrated in FIG. 5 is the CPU 101, description will be made with the functional components as executors. The same goes for subsequent flowcharts.

At OP101, the control unit 12 determines whether or not weight information has been received from the sensor apparatus 2 through the reception unit 11. If the weight information has been received from the sensor apparatus 2 (OP101: YES), the process proceeds to OP102. If the weight information has not been received from the sensor apparatus 2 (OP101: NO), the process illustrated in FIG. 5 ends. If the weight information has been received, the control unit 12 stores the received weight information into a predetermined storage area of the memory 102. At this time, weight information received last time may be overwritten with the weight information received this time, or the latest weight information corresponding to a predetermined number of times including the weight information received this time may be held.

At OP102, the control unit 12 compares a measured value included in the received weight information and a measured value included in the last weight information from the sensor apparatus 2 and determines whether or not the current measured value has increased or decreased from the last measured value. If the current measured value has increased or decreased from the last measured value (OP102: YES), the process proceeds to OP103. If the current measured value has not increased or decreased from the last measured value (OP102: NO), the process illustrated in FIG. 5 ends. When the weight information is received for the first time, the last measured value does not exist. Therefore, the last measured value is assumed to be zero, and the measured value increases. Thus, the determination at OP102 is a positive determination.

At OP103, the control unit 12 determines whether or not a quantity of the increase or decrease from the last measured value to the current measured value is a multiple of the weight per one article of the product 500. The weight per one article of the product 500 is acquired from a value of the field of weight per one article in an entry in which a value of the field of sensor ID corresponds to identification information about a weight sensor included in the received weight information, in a stock information table corresponding to user identification information included in the received weight information in the stock information DB 15. If the quantity of the increase or decrease from the last measured value to the current measured value is a multiple of the weight per one article of the products 500 (OP103: YES), the process proceeds to OP104. If the quantity of the increase or decrease from the last measured value to the current measured value is not a multiple of the weight per one article of the products 500 (OP103: NO), the process illustrated in FIG. 5 ends.

At OP104, the control unit 12 updates the estimated quantity of stock of the products 500 managed by the relevant weight sensor, based on the measured value included in the weight information received at OP101. More specifically, the control unit 12 updates a value of the field of estimated quantity of stock in the entry in which the value of the field of sensor ID corresponds to the identification information about the weight sensor included in the received weight information, in the stock information table corresponding to the user identification information included in the received weight information in the stock information DB 15. If the estimated quantity of stock is weight, the control unit 12 updates the value of the field of estimated quantity of stock of the entry in the stock information DB 15 by adding or subtracting a value of the increase or decrease in the measured value. If the estimated quantity of stock is number, the control unit 12 performs update by adding or subtracting a value obtained by dividing the quantity of the increase or decrease from the last measured value to the current measured value by the weight per one article of the product 500 to or from the value of the field of estimated quantity of stock of the entry in the stock information DB 15.

At OP105, the control unit 12 determines whether or not the estimated quantity of stock of the product 500 is below the predetermined value. When the product 500 is managed by a plurality of weight sensors 205, that is, when there are a plurality of entries in which a value of the field of product ID corresponds to the identification information about the product 500, in the stock information table of the user in the stock information DB 15, a total value of values of the fields of estimated quantity of stock of the plurality of entries is used as the estimated quantity of stock of the product 500 at OP105.

If the estimated quantity of stock of the product 500 is below the predetermined value (OP105: YES), the process proceeds to OP106. If the estimated quantity of stock of the product 500 is equal to or above the predetermined value (OP105: NO), the process illustrated in FIG. 5 ends.

At OP106, the control unit 12 orders a predetermined quantity of product 500 from the external server 4. After that, the process illustrated in FIG. 5 ends. The process illustrated in FIG. 5 is a mere example, and the process for managing the estimated quantity of stock of the product 500 by the management server 1 is not limited to the process illustrated in FIG. 5. For example, the process at OP106 may be any process if a signal about replenishment of the product 500 is issued, may be notification that the stock of the product 500 is small, for example. A signal of automatic order of the product 500 and a signal of notification that the stock of the product 500 is small is an example of “a signal about replenishment of the product 500”.

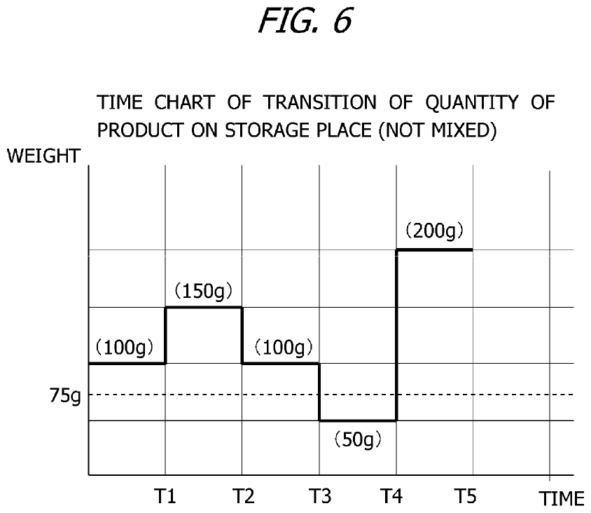

A specific example of transition of the quantity of a product stored at the storage place 200 will be described using FIGS. 6 to 8. FIG. 6 illustrates an example of a time chart of transition of the estimated quantity of stock of the product 500 in stock management by the stock management system 100 in a case where all products stored at the storage place 200 are the product 500, that is, a case where products other than the product 500 are not mixed on the storage place 200. Each of times T0 to T5 indicates a timing when measurement of the quantity of the product 500 stored at the storage place 200 is executed.

The following are assumed common to FIGS. 6 to 8: (1) the weight per one article of the product 500 is 50 g; (2) a threshold when the signal about replenishment of the product 500 is issued is 75 g, and an order quantity per one automatic order is three (150 g) for the product 500; and (3) at the time point of T0, the product 500 of 100 g (two articles) are stored at the storage place 200. A graph with solid lines indicates actual weights of the product 500 stored at the storage place 200 (measured values of the weight sensor 205), and numerical values in parentheses indicate actual quantities of stock of the product 500 stored at the storage place 200.

In FIG. 6, at the time T1, one article of product 500 (50 g) is added to the storage place 200, and the measured value of the weight sensor 205 increases by 50 g (FIG. 5, OP102: YES). Since the quantity of the increase (50 g) in the measured value is the weight per one article of the product 500 (50 g) (FIG. 5, OP103: YES), the management server 1 adds the quantity of the increase (50 g) in the measured value of the weight sensor 205 and updates the estimated quantity of stock (FIG. 5, OP104). The estimated quantity of stock at the time T1 is 150 g.

At each of the times T2 and T3, one article of product 500 is taken out from the storage place 200. The measured values of the weight sensor 205 at the times T2 and T3 are 100 g and 50 g, respectively, decreasing by 50 g (FIG. 5, OP102: YES). At each of the times T2 and T3, since the quantity of decrease (50 g) in the measured value is the weight per one article of the product 500 (50 g) (FIG. 5, OP103: YES), the management server 1 subtracts the quantity of decrease (50 g) in the measured value of the weight sensor 205 and updates the estimated quantity of stock (FIG. 5, OP104). The estimated quantity of stock at the time T2 becomes 100 g. The estimated quantity of stock at the time T3 becomes 50 g.

At the time T3, since the estimated quantity of stock of the product 500 (50 g) is below the stock threshold 75 g (FIG. 5, OP105: YES), the management server 1 orders three articles of the product 500 from the external server 4.

At the time T4, three articles of the product 500 are delivered to the user's home by automatic order; the three articles of the product 500 are added to the storage place 200; and the measured value of the weight sensor 205 becomes 200 g and increases by 150 g (FIG. 5, OP102: YES). Since the quantity of the increase (150 g) in the measured value is three times the weight per one article of the product 500 (50 g) (FIG. 5, OP103: YES), the management server 1 updates the estimated quantity of stock with the quantity of the increase (150 g) in the measured value of the weight sensor 205 (FIG. 5, OP104). The estimated quantity of stock at the time T4 is 200 g.

Therefore, in the example illustrated in FIG. 6, it is indicated that, when products other than the product 500 are not mixed on the storage place 200, the measured value of the weight sensor 205 and the estimated quantity of stock of the product 500 grasped by the management server 1 transition, being the same value.

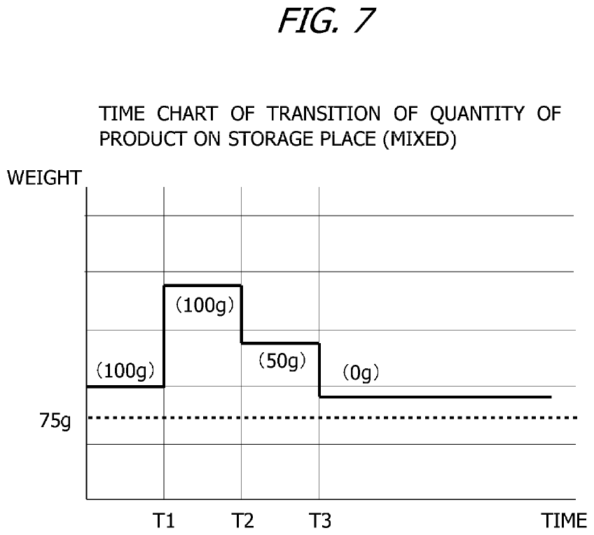

FIG. 7 illustrates an example of a time chart of transition of the estimated quantity of stock of the product 500 by stock management according to the measured value of the weight sensor in a case where products other than the product 500 are mixed. In FIG. 7, stock management by the stock management system 100 is not applied, and stock management is performed only with measured values of the weight sensor.

It is assumed that, at the time T1 in FIG. 7, one article of a product A with a weight different from the weight of the product 500 is added to the storage place 200. The weight per one article of the product A is assumed to be 90 g. At this time, the measured value of the weight sensor of the storage place 200 becomes 190 g. The quantity of stock of the product 500 at the time T1 is 100 g.

At the time T2, one article of the product 500 is taken out from the storage place 200, and the measured value of the weight sensor of the storage place 200 becomes 140 g. On the other hand, the quantity of stock of the product 500 at the time T2 is 50 g. Since the quantity of stock (50 g) of the product 500 at the time T2 is below the threshold (75 g) for the quantity of stock, a signal about replenishment of product 500 should be transmitted. In FIG. 7, however, the measured value of the weight sensor at the time T2 is 140 g, and the measured value of the weight sensor is recognized as the quantity of stock of the product 500. Therefore, the quantity of stock of the product 500 is not recognized as being below the threshold (75 g), and a signal about replenishment of the product 500 is not transmitted. Therefore, the product 500 remains unreplenished.

At the time T3, one article of the product 500 is taken out from the storage place 200, and the measured value of the weight sensor of the storage place 200 becomes 90 g. In this case also, similarly to the case of the time T2, since, though the quantity of stock of the product 500 at the time T3 (0 g) is below the threshold (75 g) for the quantity of stock, the measured value of the weight sensor at the time T3 is 90 g, which is not below the threshold (75 g) for the quantity of stock, the product 500 remains unreplenished.

Therefore, in the example illustrated in FIG. 7, it is indicated that, when stock management is performed according to measured values of the weight sensor, the quantity of stock of product 500 actually stored at the storage place 200 and the quantity of stock of product 500 grasped by the system side deviate from each other if products other than product 500 are mixed to the storage place 200. Thereby, for example, there is a possibility that replenishment of the product 500 is not performed as desired by the user.

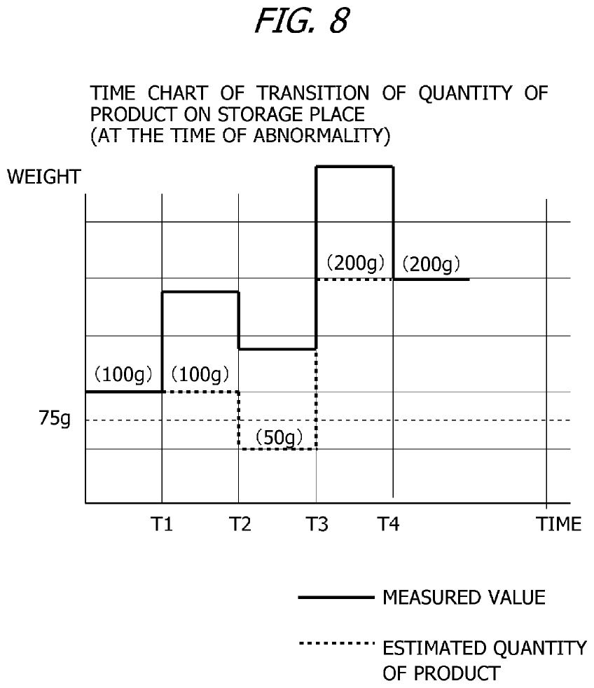

FIG. 8 illustrates an example of a time chart of transition of the estimated quantity of stock of the product 500 in stock management by the stock management system 100 in the case where products other than product 500 are mixed to the storage place 200. In FIG. 8, a graph with solid lines indicates measured values of the weight sensor 205. A dotted-line graph indicates estimated quantities of stock of product 500 grasped by the management server 1.

In FIG. 8, at the time T1, one article of a product A (90 g) different from the product 500 is added to the storage place 200, and the measured value of the weight sensor 205 becomes 190 g and increases by 90 g (FIG. 5, OP102: YES). Since the quantity of the increase (90 g) in the measured value is not the weight per one article of the product 500 (50 g) (FIG. 5, OP103: NO), the management server 1 does not update the estimated quantity of stock (100 g) of the product 500. Therefore, the estimated quantity of stock at the time T1 is 100 g.

At the time T2, one article of the product 500 is taken out from the storage place 200. The measured value of the weight sensor 205 at the time T2 becomes 140 g and decreases by 50 g (FIG. 5, OP102: YES). At the time T2, since the quantity of decrease (50 g) in the measured value is the weight per one article of the product 500 (50 g) (FIG. 5, OP103: YES), the management server 1 subtracts the quantity of the decrease (50 g) in the measured value of the weight sensor 205 and updates the estimated quantity of stock (FIG. 5, OP104). The estimated quantity of stock at the time T2 becomes 50 g.

At the time T2, since the estimated quantity of stock of the product 500 (50 g) is below the stock threshold 75 g (FIG. 5, OP105: YES), the management server 1 orders three article of the product 500 from the external server 4.

At the time T3, three article of the product 500 are delivered to the user's home by automatic order, and the three article of the product 500 are added to the storage place 200. Thereby, the measured value of the weight sensor 205 becomes 290 g and increases by 150 g (FIG. 5, OP102: YES). Since the quantity of the increase (150 g) in the measured value is three times the weight per one article of the product 500 (50 g) (FIG. 5, OP103: YES), the management server 1 adds the quantity of the increase (150 g) in the measured value of the weight sensor 205 to update the estimated quantity of stock (FIG. 5, OP104). The estimated quantity of stock at the time T4 is 200 g.

Therefore, in the example illustrated in FIG. 8, it is indicated that, even when products other than the product 500 are mixed to the storage place 200, the measured value of the weight sensor 205 and the estimated quantity of stock of the product 500 grasped by the management server 1 transition, being the same value, according to the stock management by the stock management system 100.

<Operation and Effects of First Embodiment>

According to the first embodiment, according to whether or not the quantity of an increase or decrease in the measured value of the weight sensor 205 provided on the storage place 200 is a multiple of the weight per one article of the product 500, the estimated quantity of stock stored at the storage place 200 is updated. Thereby, it is possible to manage the quantity of stock of the product 500 stored at the storage place 200 more accurately. Here, “accurately” means that the quantity of product 500 stored at the storage place 200, which is grasped by the management server 1, and the quantity of product 500 that are actually stored at the storage place 200 match each other.

Further, in the first embodiment, since it is possible to manage the quantity of stock of product 500 stored at the storage place 200 more accurately even without using a sensor other than the weight sensor 205, the sensor apparatus 2 can be in a simpler configuration.

Further, in the first embodiment, if the estimated quantity of stock of product 500 is below the predetermined value, the management server 1 transmits a signal about replenishment of the product 500. Thereby, the possibility that the storage place 200 is replenished with product 500 becomes stronger, and, therefore, it is possible to facilitate stock management of the product 500.

<Modification 1>

In the first embodiment, if the quantity of an increase or decrease in the measured value of the weight sensor 205 provided on the storage place 200 is not a multiple of the weight per one article of the product 500, the estimated quantity of stock of product 500 is not updated. However, there may be a case where a product corresponding to the quantity of the increase or decrease in the measured value are a product of the same kind as the product 500, and the user desires to manage the product equally to the product 500.

Therefore, in the modification 1, if the quantity of an increase or decrease in the measured value of the weight sensor 205 provided on the storage place 200 is not a multiple of the weight per one article of the product 500, the management server 1 inquires of the user about whether or not to cause the product corresponding to the quantity of the increase or decrease in the measured value to be a management target. If the user answers that the product are to be a management target, the management server 1 reflects the quantity of the increase or decrease in the measured value on the estimated quantity of stock of the product 500.

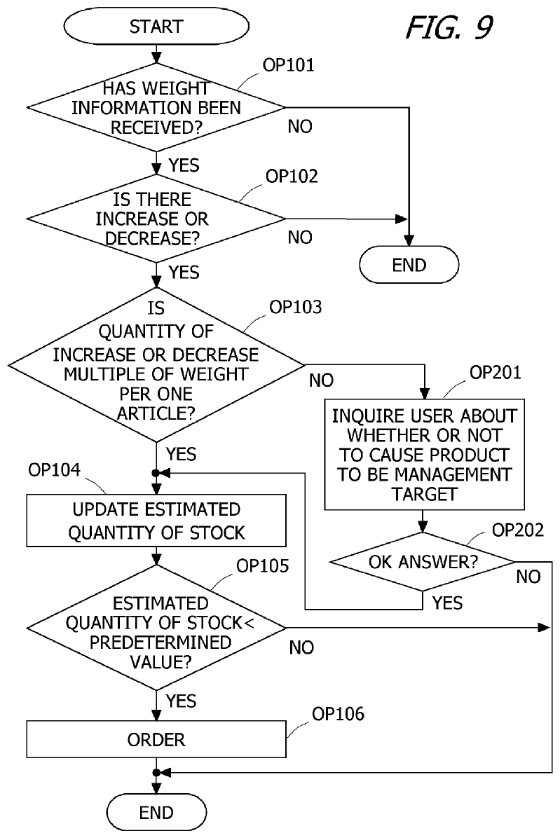

FIG. 9 illustrates an example of a flowchart of a process for managing the estimated quantity of stock of the product 500 by the management server 1 according to the modification 1. In FIG. 9, the same reference signs are given to the same processes as the process for managing the estimated quantity of stock of the product 500 by the management server 1 according to the first embodiment (FIG. 5).

In FIG. 9, if weight information is received from the sensor apparatus 2 (OP101: YES), and there is an increase or decrease from the last measured value to the current measured value (0P102: YES), and the quantity of the increase or decrease in the measured value is not a multiple of the weight per one article of the product 500 (OP103: NO), then the process proceeds to OP201.

At OP201, the control unit 12 transmits an inquiry about whether or not to cause the added or reduced product to be a management target to be stored to the storage place 200, to the user terminal 3. At OP202, the control unit 12 determines whether or not an OK answer has been received from the user terminal 3. If the OK answer has been received from the user terminal 3 (OP202: YES), the process proceeds to OP 104, and the estimated quantity of stock of product 500 is updated (OP104).

According to the modification 1, if a product mixed to the storage place 200 is a product that the user wants to be management targets together with the product 500, it is possible to cause the product mixed on the storage place 200 to be a management target.

<Modification 2>

For example, when one tier of storage shelves provided with a plurality of tiers is the storage place 200 for the product 500, and another tier is used for a storage place for another product B, it is conceivable that the product B may be wrongly placed on the storage place for the product 500. In the modification 2, in such a case, the management server 1 transmits an error to the user terminal 3 to cause it to be noticed that the storage place of the product B is wrong.

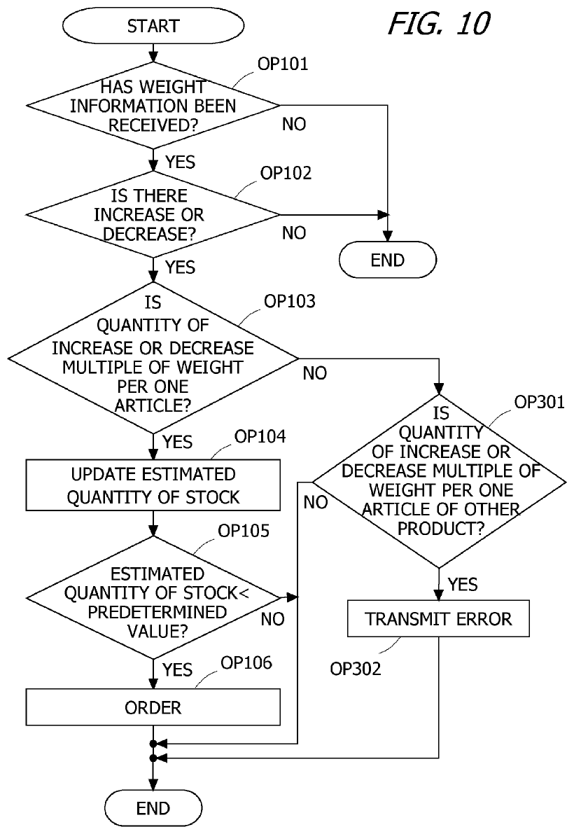

FIG. 10 illustrates an example of a flowchart of a process for managing the estimated quantity of stock of the product 500 by the management server 1 according to the modification 2. In FIG. 10, the same reference signs are given to the same processes as the process for managing the estimated quantity of stock of the product 500 by the management server 1 according to the first embodiment (FIG. 5).

In FIG. 10, if weight information is received from the sensor apparatus 2 (OP101: YES), and there is an increase or decrease from the last measured value to the current measured value (OP102: YES), and the quantity of the increase or decrease in the measured value is not a multiple of the weight per one article of the product 500 (OP103: NO), then the process proceeds to OP301.

At OP301, the control unit 12 determines whether or not the quantity of the increase or decrease in the measured value is a multiple of a weight per one article of a product associated with another sensor, for example, in the stock information table of the user included in the weight information, in the stock information DB 15. If the quantity of the increase or decrease in the measured value is a multiple of the weight per one article of the product associated with the other sensor (OP301: YES), the process proceeds to OP302. If the quantity of the increase or decrease in the measured value is not a multiple of the weight per one article of the product associated with the other sensor (OP301: NO), the process illustrated in FIG. 10 ends.

At OP302, the control unit 12 transmits an error message indicating mixture of a product to be stored to another storage place, to the user terminal 3. After that, the process illustrated in FIG. 10 ends.

According to the modification 2, for example, when the user stores a product to a wrong storage place, it is possible to cause the user to notice it.

### Other Embodiments

The embodiment described above is an example, and the present disclosure may be changed and carried out as appropriate without departing from the gist of the present disclosure.

According to the first embodiment and the modifications, it is assumed that a single product 500 is stored at one storage place 200. Without being limited thereto, it is possible to store a plurality of products on one storage place 200 if the products are different in weight per one article, and the weight per one article of one product is not a multiple of the weight per one article of another product. For example, a case where a product #1 and a product #2 are stored at a storage place will be explained. In this case, for example, the control unit 12 can determine at OP103 of FIG. 5 whether or not the quantity of an increase or decrease in the measured value of the weight sensor 205 corresponds to a weight of a combination of the number of articles of the product #1 and the number of articles of the product #2. The combination of the number of articles of the product #1 and the number of articles of the product #2 is a combination within a range of the sum of the weights of the product #1 and the product #2 not exceeding the quantity of the increase or decrease in the measured value. As the combination of the number of articles of the product #1 and the number of articles of the product #2, a case where the number of articles of the product #1 is zero, or the number of articles of the product #2 is zero is included. In a case where three or more different products are stored at the storage place 200, it is also possible to similarly perform stock management.

The processes and means described in the present disclosure may be freely combined to the extent that no technical conflict exists.

A process which is described to be performed by one device may be performed divided among a plurality of devices. Processes described to be performed by different devices may be performed by one device. Each function is to be implemented by which hardware component (server component) in a computer system may be flexibly changed.

The present disclosure may also be implemented by supplying a computer program for implementing a function described in the embodiment above to a computer, and by reading and executing the program by at least one processor of the computer. Such a computer program may be provided to a computer by a non-transitory computer-readable storage medium which is connectable to a system bus of a computer, or may be provided to a computer through a network. The non-transitory computer-readable storage medium may be any type of disk such as a magnetic disk (floppy (registered trademark) disk, a hard disk drive (HDD), etc.), an optical disk (CD-ROM, DVD disk, Blu-ray disk, etc.), a read only memory (ROM), a random access memory (RAM), an EPROM, an EEPROM, a magnetic card, a flash memory, an optical card, and any type of medium which is suitable for storing electronic instructions.

What is claimed is:

1. An information processing apparatus comprising a processor, the processor being configured to execute acquiring a quantity of stock of a first product stored at a storage place based on a measured value indicating a weight of a load at the storage place by a weight sensor installed at the storage place, wherein
the processor executes:
acquiring a weight per one article of the first product;
determining, when there is an increase or decrease from a last measured value to the current measured value of the weight sensor, whether or not the increase or decrease in the measurement value is due to addition or reduction of the first product, based on the weight per one article; and
updating the quantity of stock when it is determined that the increase or decrease in the measured value is due to addition or reduction of the first product, and not updating the quantity of stock when it is determined that the increase or decrease in the measured value is not due to addition or reduction of the first product.

2. The information processing apparatus according to claim 1, wherein the processor determines whether or not the increase or decrease in the measured value is due to addition or reduction of the first product by whether or not a quantity of the increase or decrease in the measured value is a multiple of the weight per one article.

3. The information processing apparatus according to claim 1, wherein, if determining that the increase or decrease in the measured value is not due to addition or reduction of the first product, the processor confirms whether or not to reflect a quantity of the increase or decrease in the measured value on the quantity of stock, to a user associated with the storage place.

4. The information processing apparatus according to claim 2, wherein the processor
determines whether or not the quantity of the increase or decrease in the measured value is a multiple of a weight per one article of another product when determining that the increase or decrease in the measured value is not due to addition or reduction of the first product; and
notifies a user associated with the storage place of mixture of the other product to the storage place when the quantity of the increase or decrease in the measured value is a multiple of the weight per one article of the other product.

5. The information processing apparatus according to claim 4, wherein the other product is a product stored at another storage place associated with the user and provided with another weight sensor.

6. The information processing apparatus according to claim 1, wherein, when the quantity of stock is below a predetermined value, the processor further executes transmitting a signal about replenishment of the first product.

7. The information processing apparatus according to claim 6, wherein the processor transmits, as the signal, a signal to order the first product.

8. The information processing apparatus according to claim 6, wherein the processor transmits, as the signal, a signal notifying a user associated with the storage place that the quantity of stock is below the predetermined value.

9. The information processing apparatus according to claim 1, wherein,
when the first product and a second product are mixed and stored at the storage place, the processor executes:
further acquiring a weight per one article of the second product;
determining, when there is the increase or decrease from the last measured value to the current measured value of the weight sensor, whether or not the increase or decrease in the measurement value is due to addition or reduction of at least one of the first product and the second product, based on the weight per one article of the first product and the weight per one article of the second product; and
updating at least one of the quantity of stock of the first product and a quantity of stock of the second product when determining that the increase or decrease in the measured value is due to addition or reduction of at least one of the first product and the second product, and updating neither the quantity of stock of the first product nor the quantity of stock of the second product when determining that the increase or decrease in the measured value is not due to addition or reduction of the first product or the second product.

10. The information processing apparatus according to claim 9, wherein, when a quantity of the increase or decrease in the measured value does not correspond to any of weights of combinations of numbers of articles of the first product and numbers of articles of the second product, the processor determines that the increase or decrease in the measured value is not due to addition or reduction of the first product or the second product.

11. An information processing method executed by a computer configured to execute acquiring a quantity of stock of a first product stored at a storage place based on a measured value indicating a weight of a load at the storage place by a weight sensor installed at the storage place, the method comprising:
acquiring a weight per one article of the first product;
determining, when there is an increase or decrease from a last measured value to the current measured value of the weight sensor, whether or not the increase or decrease in the measurement value is due to addition or reduction of the first product, based on the weight per one article; and
updating the quantity of stock when it is determined that the increase or decrease in the measured value is due to addition or reduction of the first product, and not updating the quantity of stock when it is determined that the increase or decrease in the measured value is not due to addition or reduction of the first product.

12. The information processing method according to claim 11, wherein it is determined whether or not the increase or decrease in the measured value is due to addition or reduction of the first product by whether or not a quantity of the increase or decrease in the measured value is a multiple of the weight per one article.

13. The information processing method according to claim 11, further comprising, when it is determined that the increase or decrease in the measured value is not due to addition or reduction of the first product, confirming whether or not to reflect a quantity of the increase or decrease in the measured value on the quantity of stock, to a user associated with the storage place.

14. The information processing method according to claim 12, further comprising,
determining whether or not the quantity of the increase or decrease in the measured value is a multiple of a weight per one article of another product when it is determined that the increase or decrease in the measured value is not due to addition or reduction of the first product, and,
notifying a user associated with the storage place of mixture of the other product to the storage place when the quantity of the increase or decrease in the measured value is a multiple of the weight per one article of the other product.

15. The information processing method according to claim 14, wherein the other product is a product stored at another storage place associated with the user and provided with another weight sensor.

16. The information processing method according to claim 11, further comprising, when the quantity of stock is below a predetermined value, transmitting a signal about replenishment of the first product.

17. The information processing method according to claim 16, further comprising transmitting, as the signal, a signal to order the first product.

18. The information processing method according to claim 16, further comprising transmitting, as the signal, a signal notifying a user associated with the storage place that the quantity of stock is below the predetermined value.

19. The information processing method according to claim 11, further comprising:
when the first product and a second product are mixed and stored at the storage place,
further acquiring a weight per one article of the second product;
determining, when there is the increase or decrease from the last measured value to the current measured value of the weight sensor, whether or not the increase or decrease in the measurement value is due to addition or reduction of at least one of the first product and the second product, based on the weight per one article of the first product and the weight per one article of the second product; and
updating at least one of the quantity of stock of the first product and a quantity of stock of the second product when determining that the increase or decrease in the measured value is due to addition or reduction of at least one of the first product and the second product, and updating neither the quantity of stock of the first product nor the quantity of stock of the second product when determining that the increase or decrease in the measured value is not due to addition or reduction of the first product or the second product.

20. The information processing method according to claim 19, wherein, when a quantity of the increase or decrease in the measured value does not correspond to any of weights of combinations of numbers of articles of the first product and numbers of articles of the second product, it is determined that the increase or decrease in the measured value is not due to addition or reduction of the first product or the second product.
